(19) United States
(12) Patent Application Publication
(10) Pub. No.: US 2017/0277365 A1
(43) Pub. Date: Sep. 28, 2017

(54) CONTROL SYSTEM FOR USER APPAREL SELECTION

(71) Applicant: Intel Corporation, Santa Clara, CA (US)

(72) Inventors: TAMARA GAIDAR, Haifa (IL); PATRICK J. NESCHLEBA, Mountain View, CA (US); AMIT MORAN, Tel Aviv (IL); RICHARD T. BECKWITH, Hillsboro, OR (US); YOSI GOVEZENSKY, Nofit (IL)

(73) Assignee: Intel Corporation, Santa Clara, CA (US)

(21) Appl. No.: 15/082,154

(22) Filed: Mar. 28, 2016

(51) Int. Cl. G06F 3/0482; G06F 3/16; G06Q 30/06; G06K 9/00

(52) U.S. Cl. CPC G06F 3/0482; G06K 9/00302; G06K 9/00335; G06F 3/167; G06Q 30/0631; G06Q 30/0643

(57) ABSTRACT

This disclosure is directed to a control system for user apparel selection. A system may comprise a control device to receive information from at least one sensor in an environment where apparel selection may commonly take place (e.g., closet). The control device may include communication circuitry, user interface circuitry, closet controller circuitry, etc. to receive user sensor data and apparel sensor data from the at least one sensor. Some or all of this data may be provided to at least one external resource such as, for example, an apparel designer, an apparel manufacturer, a feedback accumulation website, etc., to elicit at least styling data. Apparel control logic within the device may utilize the above data along with context data that describes, for example, the event for which the apparel is required, environmental data (e.g., weather), etc. to disposition apparel, suggest at least one piece of apparel to the person, etc.

### TECHNICAL FIELD

The present disclosure relates to control systems, and more particularly, to a system that may suggest apparel to a user based on sensed user data, sensed apparel data, external data, etc.

### BACKGROUND

The increasing pressures of modern existence are causing people to attempt to compress more activities into each day. However, the days are already packed. People must wake earlier and work longer hours while still setting aside time to attend to personal matters. Often there is not enough time in a day to get everything done that was planned, causing people to delay their personal needs to make sure their professional lives are addressed. While these sacrifices may appear to only affect a person's personal life, they may in actuality influence both personal and professional activities. For example, people may consider maintaining wardrobe and apparel to be a personal activity, but appearance may also affect how people are perceived professionally. A person who does not maintain their clothes properly, wears the same clothes repeatedly, does not follow style trends, does not maintain clothing for all occasions, does not dress appropriately based on the personal or professional event that is being attended risks poor perception by others. As a result, the maintenance of a person's apparel is not a task that should be taken lightly.

Modern technology has improved the lives of people in many facets, but not substantially in the maintenance of a person's apparel. For example, people now carry mobile communication devices that are capable of performing a variety of tasks. Smart phones not only allow people to communicate via voice interaction, but support data communication via a variety of wired and/or wireless mediums. As a result, people may be able to perform a variety of tasks on the move that were previously only available via stationary computing devices. Similar achievements have not been realized when it comes to maintaining a person's wardrobe. Closets may comprise motion-sensing switches to flip on the lights automatically, but automation over and beyond light control is still limited. Automated systems have been proposed to facilitate virtual interaction between a user and their wardrobe. These systems may take context (e.g., weather) into consideration when proposing a wardrobe, and do not address maintaining a wardrobe so that apparel for a variety of different occasions is ready to go in appropriate condition and in accordance with modern style.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example control system for user apparel selection in accordance with at least one embodiment of the present disclosure;

FIG. 2 illustrates an example configuration for a closet system usable in accordance with at least one embodiment of the present disclosure;

FIG. 3 illustrates example apparel control logic and data flow in accordance with at least one embodiment of the present disclosure; and

FIG. 4 illustrates example operations for apparel maintenance and selection in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure is directed to a control system for user apparel selection. In general, a system may comprise at least one control device configured to receive information from at least one sensor in an environment where apparel selection may commonly take place (e.g., a person's closet). The control device may receive user sensor data and apparel sensor data from the at least one sensor. User sensor data may include body dimension data, facial expressions, gestures, tone of voice, etc. This data may be used to determine a user's current physical disposition and mood. The apparel sensor data may include data used to determine the condition of the apparel such as, for example, data indicating whether the apparel needs to be washed, whether the apparel needs to be mended, etc., the frequency that the person is wearing the apparel, etc. Some or all of this data may be provided to at least one external resource (e.g., accessible via a network) such as, for example, an apparel designer, an apparel manufacturer, a feedback accumulation website, etc., to elicit at least styling data. Styling data may suggest different combinations of apparel taken from the person's current wardrobe, may suggest to add or remove apparel from the wardrobe, etc. In the instance that a new piece of apparel is suggested, user interface circuitry within or coupled to the control device may present a user interface facilitating the purchase of the apparel. Apparel control logic within the device may utilize the above data along with context data that describes, for example, the event for which the apparel is required (e.g., casual, formal, required dress code, etc.), environmental data (e.g., weather, typical environmental conditions within a certain venue, etc.) when dispositioning apparel (e.g., identify apparel for servicing including, for example, washing, laundering, repair, alteration, etc., identify apparel for removal including, for example, for donation or discarding, etc.), suggesting at least one piece of apparel to the person, etc.

In at least one embodiment, an example control device to suggest apparel may comprise at least communication circuitry, user interface circuitry and closet controller circuitry. The communication circuitry may be to at least receive user sensor data, apparel sensor data and styling data. The closet controller circuitry may be to input apparel inventory data, context data, the user sensor data, the apparel sensor data and the styling data into the apparel control logic and to cause the user interface circuitry to present to the user at least one of a suggestion of at least one piece of apparel or an alert regarding at least one piece of apparel based on an output of the apparel control logic.

In at least one embodiment, the user sensor data may be received in the communication circuitry from sensor circuitry that senses at least one of a physical dimension of the user, a facial characteristic of the user, a gesture made by the user or a sound generated by the user. The closet controller circuitry may be to determine a mood for the user based on at least one of the facial characteristic of the user, the gesture made by the user or the sound generated by the user sensed by the sensor circuitry and input the mood into the apparel control logic. The apparel sensor data may be received in the communication circuitry from sensor circuitry that senses at least one of apparel usage or apparel condition. In at least one example implementation, the closet controller circuitry may further be to cause the communication circuitry to request the user sensor data and the apparel sensor data from the sensor circuitry based on at least one triggering event.

In at least one embodiment, the styling data may be received from at least one external resource including at least a data handling resource maintained by an apparel manufacturer, the styling data including at least one piece of apparel suggested by the manufacturer. The communication circuitry may be to transmit at least the apparel sensor data to the at least one external resource for use in determining the styling data. The styling data may further comprise suggestions of new apparel to purchase from the manufacturer, the closet controller circuitry further causing the user interface circuitry to present a user interface to the user allowing the new apparel to be purchased. In the same or a different embodiment, the at least one external resource may also comprise a data accumulation resource for at least one third party, the styling data being generated at least in part based on data collected provided from the at least one third party.

In at least one embodiment, the closet controller circuitry may be to disposition apparel listed in the apparel inventory data for at least one of servicing or removal based on at least one of the apparel sensor data and the styling data. The context data may comprise at least one of a context of an event for which apparel is required or environmental data. Consistent with the present disclosure, an example method for controlling apparel suggestion may comprise receiving user sensor data, apparel sensor data and styling data in a device including communication circuitry, user interface circuitry and closet controller circuitry, causing the closet controller circuitry to input apparel inventory data, context data, the user sensor data, the apparel sensor data and the styling data into the apparel control logic and causing the user interface circuitry to present to the user at least one of a suggestion of at least one piece of apparel or an alert regarding at least one piece of apparel based on an output of the apparel control logic.

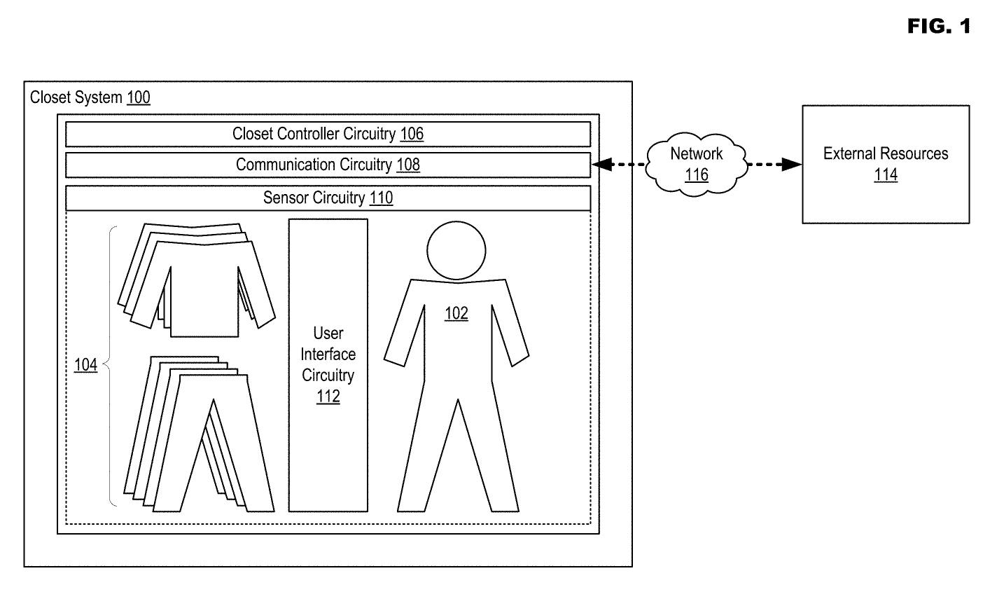

FIG. 1 illustrates an example control system for user apparel selection in accordance with at least one embodiment of the present disclosure. The following may make reference to, or may use terminology commonly associated with, certain technologies for sensing comprising, but not limited to, face detection, facial feature recognition, mood determination based on facial features, chemical sensing, odor sensing, depth sensing, etc. These examples are provided merely for the sake of explanation, and are not intended to limit any of the various embodiments consistent with the present disclosure to any particular manner of implementation. While the above technologies provide a basis for understanding these embodiments, actual implementations may utilize other technologies existing now or developed in the future. Moreover, the inclusion of an apostrophe after a drawing item number (e.g., 100′) in the present disclosure may indicate that an example embodiment of the particular item is being illustrated merely for the sake of explanation herein.

As referenced herein, “apparel” may generally comprise clothing but may also include other articles that may be worn such as, but not limited to, jewelry, shoes, hats and other items worn on the head, accessories (e.g., belts, bags, accoutrements, etc.), etc. Individual pieces of apparel may make up a wardrobe. An inventory of apparel may include a listing, file, database etc. that may identify apparel in a person's wardrobe. A closet is referenced herein as a place in which embodiments consistent with the present disclosure may be implemented. However, this is merely for the sake of example. While a closet is a common location for apparel selection to occur, other possible locations include a bedroom, dressing room, changing room, bathroom, etc.

FIG. 1 illustrates an example system 100 implemented in a closet. A closet may serve as an appropriate location to implement system 100 in that it may be spatially proximate to user 102 and/or apparel 104 when dispositioning apparel, suggesting apparel to user 102, etc. System 100 may comprise, for example, at least closet controller circuitry 106, communication circuitry 108, sensor circuitry 110 and user interface circuitry 112. It at least one example implementation, closet controller circuitry 106, communication circuitry 108 and possibly user interface circuitry 112 may reside within the same device or within multiple devices that are configured to operate in collaborative manner. While at least one device dedicated to executing apparel selection may be permanently installed in closet system 100, it may also be possible for generalized computing and/or communication devices to be temporarily reconfigured to perform apparel selection. For example, apparel selection may be initiated by executing a certain application. Example devices usable in system 100 may include, but are not limited to, a mobile communication device such as a cellular handset or a smartphone based on the Android® OS from the Google Corporation, iOS® or Mac OS® from the Apple Corporation, Windows® OS from the Microsoft Corporation, Tizen® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, server, a group of computing devices in a high performance computing (HPC) architecture, a smart television or other “smart” device, small form factor computing solutions (e.g., for space-limited applications, TV set-top boxes, etc.) like the Next Unit of Computing (NUC) platform from the Intel Corporation, etc.

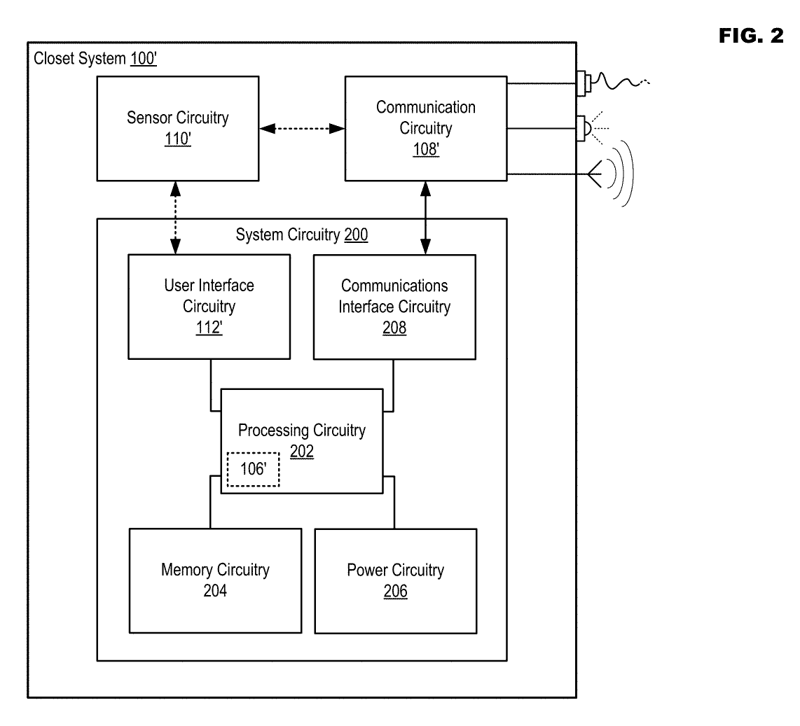

Closet controller circuitry 106 may control the operation of closet system 100 including, but not limited to, collecting data from various sources (e.g., sensor circuitry 110 and/or external resources 114), entering the collected data into apparel control logic, dispositioning apparel 104, making suggestions of at least one piece of apparel to user 102, etc. Dispositioning may include, for example, determining whether pieces of apparel 104 need to be serviced (e.g., to be washed, laundered, repaired, altered, etc.), removal from apparel inventory and no longer considered for suggestion to user 102 (e.g., to be stored for later use, donated or discarded), etc. In at least one embodiment, closet controller circuitry 106 may signal disposition to user 102 via suggestions, alerts, etc. Alerts may comprise audible, visible and/or tactile indications provided to user that a piece of apparel requires dispositioning for servicing or removal as described above. Suggesting pieces of apparel 104 to user 102 may comprise indicating (e.g., via user interface circuitry 112) at least one piece of apparel 104 for user 102 to wear, don, accessorize with or buy in the instance that user 102 does not already own apparel 104. Indicating may include presenting at least one piece of apparel 104 to user 102 on a display within user interface circuitry 112 (e.g., possibly embedded in, or adjacent to, at least one mirror in closet system 100 or somewhere else convenient for user 102 view/access while dressing), illuminating or otherwise actuating an indicator within closet system 100 to point out the location of the at least one piece of apparel 104 to user 102, causing automation within closet system 100 (e.g., movable conveyors, shelves, etc.) to position the at least one piece of suggested apparel 104 proximate to user 104 so that is may be accessed, etc. Alone or in combination with suggesting at least one piece of apparel 108, closet controller circuitry 106 may also be capable of alerting user 102 when a piece of apparel (e.g., manually selected by user 102) may not be appropriate for an eminent event based on, for example, the environment of the event (e.g., inside vs. outside), the formality of the event, a dress code governing the event, a stylistic guideline (e.g., not wearing white after Labor day), a newly emerging stylistic trend, etc. Subsequent interaction may include user 102 accepting the suggestion, requesting a new suggestion, etc. The suggestion of at least one piece of apparel 104 may be based on a variety of inputs such as user sensor data, apparel sensor data, context data, styling data, etc. These types of data and the manner in which they may be collected will be discussed below. Closet controller circuitry 106 may interact with sensor circuitry 110 and/or external resources 114 via communication circuitry 108. Communication circuitry 108 may, in general, facilitate wired and/or wireless communication as will be described in regard to FIG. 2. Closet controller circuitry 106 may also control the higher level access and control features of closest system 100. For example, access control to closet system 100 (e.g., to simply operate system 100 or to physically access the closet through the control of an electronic door lock) may be controlled by closet controller circuitry 106. For example, user 102 may be authenticated via biometric identification (e.g., face detection/recognition, fingerprint scan, retina scan, etc.), prior to unlocking a closet door, enabling a software user interface portion of closet system 100, etc. Further security-related controls that may be managed by closet controller circuitry 106 include, but are not limited to, controlling what data is shared with entities outside of closet system 100, who has access to the data (e.g., user 102 may desire to keep personal apparel inventory and/or interest data private from certain other people such as family members), the data to be stored by closet system 100, data limits for storage, etc. Moreover, software portions of closet controller circuitry 106 may be modular in that they may be loaded, updated, deleted, etc. like applications. Security control enforced by closet controller circuitry 106 may determine what applications are allowed to access what subsystems within closet system 100 (e.g., sensor circuitry 110 including, for example, cameras, microphones, etc.), to what degree is access to a subsystem permitted, etc.

In at least one embodiment, sensor circuitry 110 may comprise at least one sensor for sensing user 102 and/or apparel 104. For example, sensor circuitry 110 may comprise a visual capture sensor (e.g., camera) to generate images, video and/or depth data (e.g., such as based on RealSense technology from the Intel Corporation), infrared sensors, proximity sensors, motion sensors, acceleration/speed sensors, chemical sensors, temperature sensors, orientation sensors and other types of sensors existing now or developed in the future. Sensor circuitry 110 may be installed within closet system 100 in a standalone configuration or may be integrated in different parts of closet system 100. For example, mirrors may comprise visual capture sensors, shelves, hooks and/or clothing hangers may comprise scanners to identify apparel (e.g., bar code readers), proximity sensors, weight sensors, chemical sensors, etc. These example sensors may operate alone or in combination to generate user sensor data and/or apparel sensor data. User sensor data may comprise data captured by sensor circuitry 110 for determining a user's body dimensions, a user's mood, etc. For example, captured images, video, depth data and/or IR data may be used to determine current body dimensions for a user. The clothing currently being worn by the user may also be captured, which may be identified to establish the size of clothing currently being worn by the user, current climate, etc. Face detection technology may be able to detect a face within a captured image or video. Facial feature determination technology may then locate facial features within the detected face, and the shape, orientation, etc. of the determined facial features may be evaluated (e.g., by a learning engine or other logical analysis tool) to determine a mood corresponding to the facial features. Apparel sensing data may include usage data and condition data. Usage data may track how often the apparel is being worn by the user. Usage data may be recorded whenever apparel 104 is removed from a designated storage area (e.g., a hanger, shelf, etc. including touch, proximity or similar sensors), whenever an identification corresponding to apparel 104 is logged as being used (e.g., via scanning a bar code, radio frequency identification (RFID) tag, a Bluetooth tag, etc.), via identification of apparel 104 worn by user 102 captured in images, video, etc. Condition data may describe whether apparel 104 is in condition to be worn. The condition data may indicate that apparel 104 requires servicing (e.g., washing, laundering, repairing, altering, etc.), removal (e.g., stored, donated or discarded), etc. Sensor circuitry 110 may comprise, for example, chemical sensors to determine when apparel 104 is odiferous and/or soiled, visual capture sensors to determine that the apparel is wrinkled, stained, broken, torn, has holes, etc. User sensor data and/or apparel sensor data may be collected periodically, based on a trigger event detected by sensor circuitry 110, based on a request received from closet controller circuitry 106, etc. and may then be provided (e.g., transmitted) to closet controller circuitry 106. Examples of trigger events may include, but are not limited to, sensing a day-to-night transition or vice-versa, sensing the approach, presence or departure of user 102, sensing modifications in the inventory of apparel 104 (e.g., due to apparel 104 being removed from closet system 100 for servicing, discarded, returned from servicing, new apparel being incorporated, etc.), sensing that apparel 104 is about to be donned by user 102, sensing that new styling data was received, etc. Moreover, user sensor data may be associated with apparel identification data and metadata used by the system to, for example, determine apparel dispositioning. Example metadata may include origin data and other history-related data, apparel-specific styling data (e.g., when a certain piece of apparel 104 was considered to be in fashion, feedback from various sources about the piece of apparel 104, etc.), laundering instruction data, cost-of-ownership data, etc. Further to the above, at least some apparel sensor data and/or apparel metadata may be scanned, entered manually, etc.

Closet controller circuitry 106 may further utilize communication circuitry 108 to interact with external resources 114 over network 116. Network 116 may include at least one of a global area network (GAN), wide area network (WAN) like the Internet, local area network (LAN), etc. External resources 114 may include, for example, at least one device accessible via network 116, which for the sake of example may be the Internet, such as a server configured to provide a web presence (e.g., a website, cloud infrastructure, etc.) for at least one entity including, for example, apparel manufacturers or “third parties” such as, but not limited to apparel designers, magazines, fashion and/or industry websites (e.g., blogs), other businesses or organizations that may collect opinion data regarding different pieces of apparel and/or combinations of apparel from the users of various websites, mobile applications, etc. (e.g., “crowd-sourced” opinion data), etc. In an example of operation, closet controller circuitry 106 may transmit data to external resources 114, and may receive styling data from external resources 114. Data transmitted to external resources may comprise at least one of apparel usage data, apparel condition data (e.g., including whether apparel 104 is no longer wearable based on condition), suggested apparel data including pieces and/or combinations of apparel 104 that were suggested to, and/or worn by, user 102, etc. This data may be employed by various entities within external resources 114 to generate styling data. For example, an apparel manufacturer and/or an apparel designed may utilize the usage data to determine whether a style is currently popular, the longevity of the style's popularity, utilize the quality data to determine whether the quality of apparel 104 was sufficient (e.g., whether apparel 104 experienced mass and/or premature failures), whether care instructions for apparel 104 need to be adjusted, etc. A website for an apparel manufacturer, retailer, designer, magazine, fashion blog, etc. may post images of apparel 104 and/or combinations of apparel 104 based on the suggestion data received from closet controller circuitry 106 and request feedback on the suggestions from users of the website. Styling data may then be generated by external resources 114 and transmitted to closet controller circuitry 106. Styling data may comprise, for example, suggestions of apparel 104 in the wardrobe of user 102 that is in style, suggested combinations of apparel 104, apparel 104 that should be removed from the wardrobe of user 102, suggestions of new apparel 104 to purchase, etc. A variety of conditions may trigger closet controller circuitry 106 to propose new apparel 104. For example, if user 102 moves to a new location (e.g., having a climate substantially different from a climate of his/her current residence), if apparel 104 in the apparel inventory of user 102 needs to be replaced, if styles change, if user 102 has a change in his/her personal circumstance (e.g., enters high school, goes to college, gets a new job, etc.), etc. Apparel 104 typically worn by user 102 may also be subject to workplace uniform requirements, sports team/club uniform requirements, etc. Associated apparel 104 may need to be purchased from certain preferred apparel vendors. In such an instance, closet controller circuitry 106 may be automatically configured and/or manually configured to associate certain apparel 104 (or types of apparel 104) with preferred apparel vendors, to make new apparel suggestions from the preferred vendors, etc. Regardless, apparel purchase suggestions for new fashion seasons may be offered, for example, from preferred designers or retailers suggesting trends based on current apparel trends. When the styling data comprises a suggestion of apparel 104 to purchase, closet controller circuitry 106 may, for example, cause user interface circuitry 112 to present the new apparel 104 alone or in conjunction with other apparel 104 in the wardrobe of user 102 (e.g., to show how the new apparel may be integrated with other apparel 104 already in the wardrobe of user 102). An option to purchase the new apparel 104 may also be presented. If user 102 selects the purchase option, user 102 may be prompted to enter purchase data (e.g., color, size, quantity, ship-to address, method of payment, etc.). Otherwise, some or all of the purchase data may be preloaded to allow user 102 to simply trigger the purchase without any further requirements.

Consistent with the present disclosure, external resources 114 may comprise one or more other closet systems. For example, closet system 100 may be linked to a plurality of other closet systems via network 116. Closet system 100 and the other closet systems may be configured to operate collaboratively to allow user 102 to share data with other users comprising, for example, pieces and/or combinations of apparel 104 that were recently worn by user 102 (e.g., possibly including actual photos of user 102 wearing apparel 104), reaction data (e.g., opinions, ratings, etc.) regarding pieces/combinations of apparel worn by other users, styling data collected from external resources 114 etc. The amount, type, frequency, etc. of data sharing with other closet systems may be configured by user 102 (e.g., utilizing user interface circuitry 112). Moreover, some of the other closet systems (e.g., owned close friends of user 102) and/or groups of closet systems (e.g., for fans of a certain apparel manufacturer or designer) may be provided with more data from closet system 100, and likewise may provide more data to closet system 100, based on user configuration. Group voting may occur based on “looks” provided by closet system 100.

In at least one embodiment, closet controller circuitry 106 may further receive context data. Context data may comprise, for example, at least event context data and environmental data. Event context data may be provided by user 102 and/or may be generated automatically. For example, user 102 may utilize user interface circuitry 112 to enter an event that user 102 is attending such as work, school, a professional event, a sporting event, a casual event, a formal event, an inside and/or outside event, an event at a venue that maintains a specific dress code, etc. Closet controller circuitry 106 may also be programmed with repeating events (e.g., work, school, etc.) may learn when certain events occur, etc. Environmental data may comprise, for example, data about an environment that user 102 is expected to experience. Environmental data may be programmed/learned by closet controller circuitry 106 (e.g., at night in November user 102 normally wears a jacket), may be received from sensor circuitry 110 (e.g., sensing day vs. night, inside/outside temperature, humidity, etc.) or may be received from external resources 114 (e.g., Internet-based resources such as weather websites, websites describing certain venues, websites describing what people in certain regions wear to events like weddings, funerals, etc.). Moreover, context algorithms may be able to predict potential future events and the context of future events. For example, contextual algorithms may predict that user 102 will spend more time outside when football season begins, that at that time warmer clothing will be needed since fall will be moving into winter, that based on the schedule, calendar, etc. of user 102 new apparel should be suggested at a certain time (e.g., new formalwear suggested prior to the holidays), etc. The context data may be considered by closet controller circuitry 106 alone or in conjunction with the user sensor data, apparel sensor data (e.g., including the apparel metadata) and styling data when formulating a suggestion of at least one piece of apparel 104 for user 102 to wear.

FIG. 2 illustrates an example configuration for closet system 100′ usable in accordance with at least one embodiment of the present disclosure. Closet system 100′ may be capable of performing any or all of the activities described with respect to FIG. 1. However, closet system 100′ is presented only as an example system usable in embodiments consistent with the present disclosure, and is not intended to limit any of the embodiments disclosed herein to any particular manner of implementation. Moreover, while illustrated as only one apparatus in FIG. 2, closet system 100′ may also be made up of multiple apparatuses configured to operate collaboratively. System circuitry 200 may manage the operation of closet system 100′. System circuitry 200 may comprise, for example, processing circuitry 202, memory circuitry 204, power circuitry 206, user interface circuitry 112′ and communication interface circuitry 208. Closet system 100′ may also include communication circuitry 108′ and sensor circuitry 110′. While communication circuitry 108′ and sensor circuitry 19′ is illustrated as separate from system circuitry 200, closet system 100′ has been provided in FIG. 2 merely for the sake of explanation in regard to various embodiments. Possible variations may include some or all of the functionality of communication circuitry 108′ and/or sensor circuitry 110′ being incorporated into system circuitry 200.

In closet system 100′, processing circuitry 202 may comprise one or more processors situated in separate components, or alternatively one or more processing cores in a single component (e.g., in a System-on-a-Chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors, microcontrollers, programmable logic controllers, etc. Examples of support circuitry may include chipsets (e.g., Northbridge, Southbridge, etc. available from the Intel Corporation) to provide an interface through which processing circuitry 202 may interact with other system components that may be operating at different speeds, on different buses, etc. in closet system 100′. Moreover, some or all of the functionality commonly associated with the support circuitry may also be included in the same package as the processor (e.g., such as in the Sandy Bridge, Broadwell and Skylake families of processors available from the Intel Corporation).

Processing circuitry 202 may be configured to execute various instructions in closet system 100′. Instructions may include program code configured to cause processing circuitry 202 to perform activities related to reading data, writing data, processing data, formulating data, converting data, transforming data, etc. Information (e.g., instructions, data, etc.) may be stored in memory circuitry 204. Memory circuitry 204 may comprise random access memory (RAM) and/or read-only memory (ROM) in a fixed or removable format. RAM may include volatile memory configured to hold information during the operation of closet system 100′ such as, for example, static RAM (SRAM) or Dynamic RAM (DRAM). ROM may include non-volatile (NV) memory circuitry configured based on BIOS, UEFI, etc. to provide instructions when closet system 100′ is activated, programmable memories such as electronic programmable ROMs (EPROMS), Flash, etc. Other examples of fixed/removable memory may include, but are not limited to, magnetic memories such as hard disk (HD) drives, electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 206 may include, for example, internal power sources (e.g., a battery, fuel cell, etc.) and/or external power sources (e.g., electromechanical or solar generator, power grid, external fuel cell, etc.), and related circuitry configured to supply closet system 100′ with the power needed to operate. User interface circuitry 112′ may include hardware and/or software to allow users to interact with closet system 100′ such as, for example, various input mechanisms (e.g., microphones, switches, buttons, knobs, keyboards, speakers, touch-sensitive surfaces, one or more sensors configured to capture images, video and/or sense proximity, distance, motion, gestures, orientation, biometric data, etc.) and various output mechanisms (e.g., speakers, displays, lighted/flashing indicators, electromechanical components for vibration, motion, etc.). Hardware in user interface circuitry 112′ may be included in closet system 100′ and/or may be coupled to closet system 100′ via a wired or wireless communication medium.

Communication interface circuitry 208 may be configured to manage packet routing and other control functions for communication circuitry 108′, which may include resources configured to support wired and/or wireless communications. In some instances, closet system 100′ may comprise more than one set of communication circuitry 108′ (e.g., including separate physical interface circuitry for wired protocols and/or wireless radios) managed by centralized communication interface circuitry 208. Wired communications may include serial and parallel wired mediums such as, for example, Ethernet, USB, Firewire, Thunderbolt, Digital Video Interface (DVI), High-Definition Multimedia Interface (HDMI), DisplayPort, etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, etc.), long range wireless mediums (e.g., cellular wide-area radio communication technology, satellite-based communications, etc.), electronic communications via sound waves, long-range optical communications, etc. In one embodiment, communication interface circuitry 208 may be configured to prevent wireless communications that are active in communication circuitry 108′ from interfering with each other. In performing this function, communication interface circuitry 208 may schedule activities for communication circuitry 108′ based on, for example, the relative priority of messages awaiting transmission. While FIG. 2 illustrates communication interface circuitry 208 and communication circuitry 108′ as separate, it may also be possible for the functionality of communication interface circuitry 208 and communication circuitry 108′ to be combined in the same circuitry.

Consistent with the present disclosure, closet controller circuitry 106′ may comprise only hardware or a combination of hardware and software. For example, at least a portion of closet controller circuitry 106′ may comprise software (e.g., an application, program files, code, data, etc.) stored in memory circuitry 204. In an example of operation, processing circuitry 202 may cause the software stored in NV memory in memory circuitry 204 to be loaded into volatile memory in memory circuitry 204 and then executed by processing circuitry 202 to transform processing circuitry 202 from general data processing circuitry (e.g., a microprocessor) into specialized circuitry that may be configured to at least perform operations such as discussed with respect to FIG. 1. In an example of operation, the software portion of closet controller circuitry 106′ may comprise one or more algorithms that when executed cause processing circuitry 202 to interact with sensor circuitry 110′, either directly or via communication circuitry 108′, to request/receive at least user sensor data and apparel sensor data. Moreover, at least the software portion of closet controller circuitry 106′ may further cause processing circuitry 202 to interact with communication circuitry 108′ to transmit some or all of the user sensor data and/or apparel sensor data to external resources 114, and to receive styling data and/or context data from external resources 114. Closet controller circuitry 106′ may then cause processing circuitry 202 to interact with at least user interface circuitry 112′, and in some instances sensor circuitry 110′ to suggest at least one piece of apparel to user 102, to then receive feedback and/or judge an emotional response regarding the reaction of user 102 to the suggested apparel, etc.

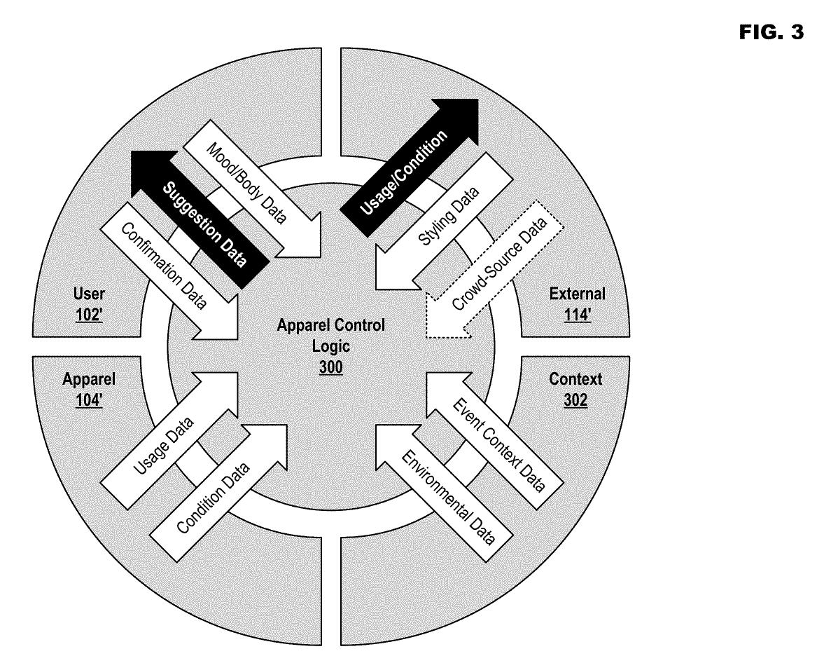

FIG. 3 illustrates example apparel control logic and data flow in accordance with at least one embodiment of the present disclosure. Apparel control logic 300 be part of closet controller circuitry 106 and may comprise, for example, one or more of logical relationships, algorithms, rules-based control, heuristic or other learning-based decision engines, etc. FIG. 3 discloses an example of data flow including information that may flow into and out of apparel control logic 300. For example, mood and body data may be captured from user 102′ for use in determining whether the user's bodily dimensions have changed (e.g., lost/gained weight, grown taller, etc.) and/or the mood of the user for determining a type of apparel (e.g., fun, formal, color, coverage, etc.). The effect of mood on the acceptance of apparel suggestions by user 102′ may be a factor learned by apparel control logic 300, controlled by styling data received from external resource 114′, etc. Apparel control logic 300 may then output a suggestion of at least one piece of apparel 104′ by presenting a piece of, or combination of, apparel 104′ (e.g., on a display in user interface circuitry 112), an indication of a location for apparel 104′ within the closet, causing automation to reconfigure the closet to bring selected apparel 104′ proximate to user 102′, etc. Confirmation data as to the suggested apparel 104′ may then be received by apparel control logic 300. This may include an input manually entered into user interface circuitry 112, user mood, gestures, etc. sensed by sensor circuitry 110′, etc. In response to receiving positive confirmation data, Apparel control logic 300 may discontinue apparel selection operations including, for example, entering an idle and/or low power mode of operations until sensor data is to be collected, the next request for apparel suggestion by user 102′, etc. Negative confirmation data may cause apparel control logic 300 to attempt an alternative apparel suggestion.

Sensor circuitry 110′ may capture, for example, at least one of usage data or condition data for apparel 104′. Apparel control logic 300 may use the usage data and/or condition data to determine apparel 104′ in an apparel inventory that user 102′ currently enjoys wearing, that may not be worn frequently by user 102′, that is ready to wear, that requires servicing (e.g., washing, laundering, repair, alteration, etc.), that should be removed from consideration for suggestion to user 102′ (e.g., stored, donated, discarded, etc.), etc. Apparel control logic 300 may further send the usage data and/or the condition data to external resources 114′ and may receive back at least styling data. Apparel control logic 300 may employ the styling data in determining apparel 104′ to suggest, combinations of apparel 104′ to suggest, apparel 104′ to disposition for removal, etc. Apparel control logic may optionally receive separate crowd-source data that may be employed in a similar manner to the styling data to determine apparel 104′ for suggestion. Otherwise, the crowd-source data may be a part of styling data that is received. Apparel control logic 300 may receive at least one of event context data or environmental data from at least one context data source 302. Apparel control logic 300 may utilize the event context data and/or environmental data for suggesting at least one piece of apparel 104′ to user 102′ based on, for example, whether an event is inside or outside, an outside temperature, an expected temperature of an event venue, whether an event is formal or casual, an amount of activity (e.g., walking, running, etc.) expected at an event, whether an event has a dress code (e.g., office-defined dress code, whether an event includes a marketing or sales call to which company logo apparel 104′ should be worn, etc.).

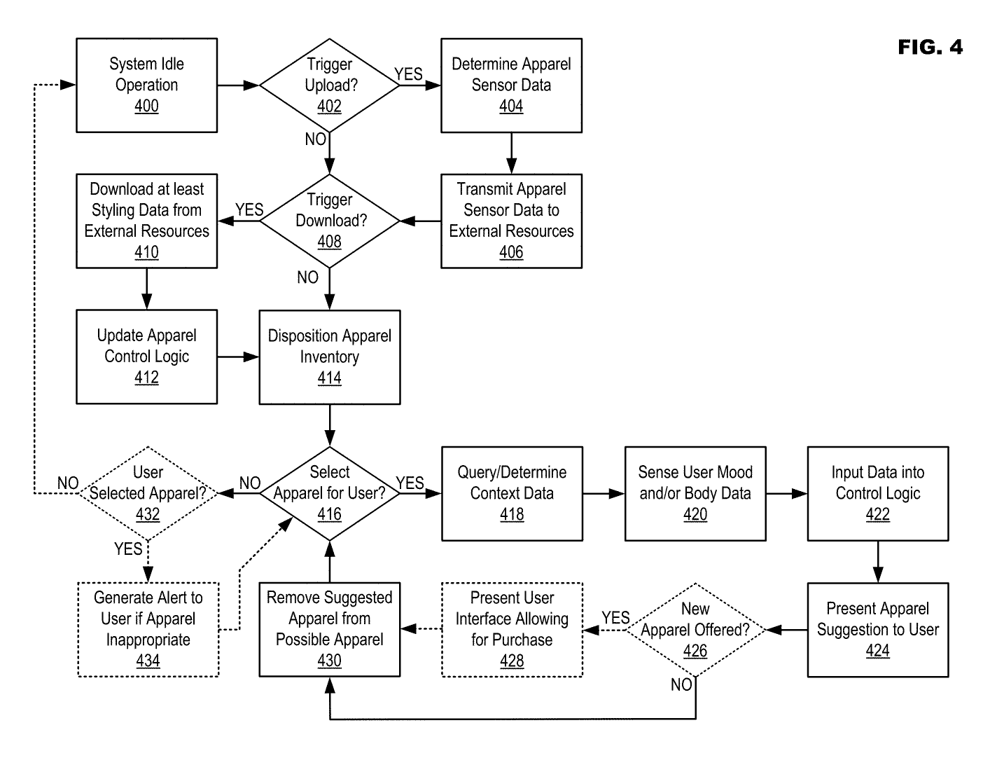

FIG. 4 illustrates example operations for apparel maintenance and selection in accordance with at least one embodiment of the present disclosure. An apparel selection assistance system may maintain in idle operation in operation 400. A determination may then be made in operation 402 as to whether a data upload has been triggered in the system. For example, the data upload may be triggered periodically, in response to a trigger event sensed by sensor circuitry, based on a request received from system controller circuitry, etc. If in operation 402 it is determined that an upload has been triggered, then in operation 404 apparel sensor data may be determined (e.g., sensed by the sensor circuitry) and in operation 406 at least some of the apparel sensor data may be transmitted to external resources. Following a determination in operation 402 that upload was not triggered, or following operation 406, a further determination may be made in operation 408 as to whether a download has been triggered in the system. A download may be triggered based on, for example, a periodic download schedule, uploading new sensor data in operations 402 to 406, a request received from the external resources, etc. If in operation 408 it is determined that a download has been triggered, then in operation 410 at least styling data (and possibly crowd-sourced data) may be downloaded from the external resources. In operation 412, apparel control logic within the system controller circuitry may be updated based on the downloaded data.

Following a determination in operation 408 that a download has not been triggered, or following operation 412, in operation 414 apparel may be dispositioned. Dispositioning may be based on the uploaded data (e.g., usage data and/or condition data) and/or the downloaded data (e.g., styling data and/or crowd-sourced data). Dispositioning may involve determining that a piece of apparel requires servicing (e.g., washing, laundering, repair, alternation, etc.) or to be removed from consideration (e.g., stored, donated, discarded, etc.). A determination may then be made in operation 416 as to whether an apparel suggestion has been requested by the user. A request for apparel suggestion in operation 416 may be followed by a query (e.g., input via user interface circuitry in the system and/or sensed by the sensing circuitry) to determine context data in operation 418. Example context data may comprise event context data and environmental data. In operation 420 user sensor data (e.g., mood and/or body data) may be sensed by the sensing circuitry. For example, a user's body dimensions may be determined to determine a sub-set of the inventory of the available apparel that may fit (e.g., and look flattering on) the user. Data including, for example, the user sensor data, the apparel sensor data, the apparel inventory data and the styling data may be into apparel control logic in operation 422. At least one piece of apparel may then be presented to the user in operation 424. For example, a piece of apparel or combination of apparel may be presented on a display in the user interface circuitry, indicators may direct the user to suggested apparel, moving hangers, shelves, etc. may be controlled to bring suggested clothing proximate to the user, etc. In at least one embodiment consistent with the present disclosure, the piece or combination of suggested apparel may include a new piece of apparel to purchase. A determination may then be made in operation 426 as to whether the suggestion including a new piece of apparel offered to the user for purchase. If in operation 426 it is determined that the suggestion included a new piece of apparel, then in operation 428 a user interface may be presented by the user interface circuitry to allow the user to purchase the new piece of apparel. Following a determination in operation 426 that a new piece of apparel was not offered, or following operation 426, the in operation 430 the suggested apparel may be removed from possible apparel to suggest in the inventory of apparel. Operation 430 is in preparation for user to accept or reject the apparel suggestion in a return to operation 416. If in operation 416 the user again requests an apparel suggestion, then removal of the previously suggested apparel in operation 430 may prevent the system from making suggestions already rejected by the user.

If in operation 416 a determination is made that apparel selection has not been requested by the user, then in optional operation 432 a determination may be made as to whether the user has selected apparel manually. A determination in operation 432 that the user has not selected apparel may be followed by a return to operation 400. If in operation 432 it is determined that the user has selected apparel, then in optional operation 434 an alert may be issued to the user if the selected apparel is determined to be inappropriate (e.g., based on the apparel control logic). Operation 434 may be followed by a return to operation 416 to allow the user the opportunity to utilize the system to select apparel, or for the user to manually select another piece of apparel.

While FIG. 4 illustrates operations according to an embodiment, it is to be understood that not all of the operations depicted in FIG. 4 are necessary for other embodiments. Indeed, it is fully contemplated herein that in other embodiments of the present disclosure, the operations depicted in FIG. 4, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software circuitry executed by a programmable control device.

Thus, this disclosure is directed to a control system for user apparel selection. A system may comprise a control device to receive information from at least one sensor in an environment where apparel selection may commonly take place (e.g., closet). The control device may include communication circuitry, user interface circuitry, closet controller circuitry, etc. to receive user sensor data and apparel sensor data from the at least one sensor. Some or all of this data may be provided to at least one external resource such as, for example, an apparel designer, an apparel manufacturer, a feedback accumulation website, etc., to elicit at least styling data. Apparel control logic within the device may utilize the above data along with context data that describes, for example, the event for which the apparel is required, environmental data (e.g., weather), etc. to disposition apparel, suggest at least one piece of apparel to the person, etc.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a control system for user apparel selection.

According to example 1 there is provided a control device to suggest apparel. The device may comprise communication circuitry to at least receive user sensor data, apparel sensor data and styling data, user interface circuitry and closet controller circuitry to input apparel inventory data, context data, the user sensor data, the apparel sensor data and the styling data into the apparel control logic and to cause the user interface circuitry to present to the user at least one of a suggestion of at least one piece of apparel or an alert regarding at least one piece of apparel based on an output of the apparel control logic.

Example 2 may include the elements of example 1, wherein the user sensor data is received in the communication circuitry from sensor circuitry that senses at least one of a physical dimension of the user, a facial characteristic of the user, a gesture made by the user or a sound generated by the user.

Example 3 may include the elements of example 2, wherein the closet controller circuitry is to determine a mood for the user based on at least one of the facial characteristic of the user, the gesture made by the user or the sound generated by the user sensed by the sensor circuitry and input the mood into the apparel control logic.

Example 4 may include the elements of any of examples 2 to 3, wherein the apparel sensor data is received in the communication circuitry from sensor circuitry that senses at least one of apparel usage or apparel condition.

Example 5 may include the elements of example 4, further comprising metadata regarding the apparel, the metadata also being input into the apparel control logic.

Example 6 may include the elements of any of examples 4 to 5, wherein the closet controller circuitry is further to cause the communication circuitry to request the user sensor data and the apparel sensor data from the sensor circuitry based on at least one triggering event.

Example 7 may include the elements of any of examples 4 to 6, wherein the styling data is received from at least one external resource including at least a data handling resource maintained by an apparel manufacturer, the styling data including at least one piece of apparel suggested by the manufacturer.

Example 8 may include the elements of example 7, wherein the communication circuitry is to transmit at least the apparel sensor data to the at least one external resource for use in determining the styling data.

Example 9 may include the elements of any of examples 7 to 8, wherein the styling data further comprises suggestions of new apparel to purchase from the manufacturer, the closet controller circuitry further causing the user interface circuitry to present a user interface to the user allowing the new apparel to be purchased.

Example 10 may include the elements of any of examples 7 to 9, wherein the at least one external resource comprises a data accumulation resource for at least one third party, the styling data being generated at least in part based on data collected provided from the at least one third party.

Example 11 may include the elements of example 10, wherein the at least one third party comprises at least one of an apparel retailer, designer, magazine, or fashion blog.

Example 12 may include the elements of any of examples 10 to 11, wherein the data accumulation resource for at least one third party comprises a website configured to gather crowd-sourced data.

Example 13 may include the elements of any of examples 10 to 12, wherein the at least one external resource comprises at least one other control device to suggest apparel.

Example 14 may include the elements of example 13, wherein a plurality of control devices to suggest apparel form a user group to exchange data.

Example 15 may include the elements of any of examples 1 to 14, wherein the closet controller circuitry is to disposition apparel listed in the apparel inventory data for at least one of service or removal based on at least one of the apparel sensor data and the styling data.

Example 16 may include the elements of any of examples 1 to 15, wherein the context data comprises at least one of a context of an event for which apparel is required or environmental data.

Example 17 may include the elements of any of examples 1 to 16, wherein the user interface circuitry is to receive an input from the user indicating that the suggestion of at least one piece of apparel has been refused.

Example 18 may include the elements of example 17, wherein the closet controller circuitry is to cause the suggested at least one piece of apparel to be removed from consideration in the apparel inventory data when making a further suggestion of at least one piece of apparel to the user.

Example 19 may include the elements of any of examples 1 to 18, wherein the control device to suggest apparel is configured to control an apparel inventory within an apparel storage structure.

Example 20 may include the elements of example 19, wherein the closet controller circuitry is further to control automation resources for automatically moving apparel within the apparel storage structure.

According to example 21 there is provided a method for controlling apparel suggestion. The method may comprise receiving user sensor data, apparel sensor data and styling data in a device including communication circuitry, user interface circuitry and closet controller circuitry, causing the closet controller circuitry to input apparel inventory data, context data, the user sensor data, the apparel sensor data and the styling data into the apparel control logic and causing the user interface circuitry to present to a user at least one of a suggestion of at least one piece of apparel or an alert regarding at least one piece of apparel based on an output of the apparel control logic.

Example 22 may include the elements of example 21, and may further comprise causing the communication circuitry to transmit at least the apparel sensor data.

Example 23 may include the elements of any of examples 21 to 22, and may further comprise causing the closet controller circuitry to disposition apparel listed in the apparel inventory data for at least one of service or removal based on at least one of the apparel sensor data and the styling data.

Example 24 may include the elements of any of examples 21 to 23, and may further comprise causing the closet controller circuitry to determine a mood for the user based on at least on the user sensor data and inputting the mood into the apparel control logic.

Example 25 may include the elements of any of examples 21 to 24, wherein the styling data is received from an apparel manufacturer, the styling data including at least one piece of apparel suggested by the manufacturer.

Example 26 may include the elements of example 25, and may further comprise determining that the styling data includes suggested new apparel for purchase from the manufacturer and causing the user interface circuitry to present a user interface to allow the user to purchase the new apparel.

Example 27 may include the elements of any of examples 21 to 26, and may further comprise removing the at least one piece of apparel presented to the user from possible pieces of apparel to suggest to the user in the apparel inventory data based on the user not accepting the at least one piece of apparel presented to the user via the user interface circuitry.

Example 28 may include the elements of any of examples 21 to 27, wherein the styling data is received from an apparel manufacturer, the styling data including at least one piece of apparel suggested by the manufacturer, the method further comprising determining that the styling data includes suggested new apparel for purchase from the manufacturer and causing the user interface circuitry to present a user interface to allow the user to purchase the new apparel.

According to example 29 there is provided a system including at least one device, the system being arranged to perform the method of any of the above examples 21 to 28.

According to example 30 there is provided a chipset arranged to perform the method of any of the above examples 21 to 28.

According to example 31 there is provided at least one machine readable medium comprising a plurality of instructions that, in response to be being executed on a computing device, cause the computing device to carry out the method according to any of the above examples 21 to 28.

According to example 32 there is provided at least one device capable of controlling apparel suggestion, the at least one device being arranged to perform the method of any of the above examples 21 to 28.

According to example 33 there is provided a system for controlling apparel suggestion. The system may comprise means for receiving user sensor data, apparel sensor data and styling data in a device including communication circuitry, user interface circuitry and closet controller circuitry, means for causing the closet controller circuitry to input apparel inventory data, context data, the user sensor data, the apparel sensor data and the styling data into the apparel control logic and means for causing the user interface circuitry present to a user at least one of a suggestion of at least one piece of apparel or an alert regarding at least one piece of apparel based on an output of the apparel control logic.

Example 34 may include the elements of example 33, and may further comprise means for causing the communication circuitry to transmit at least the apparel sensor data.

Example 35 may include the elements of any of examples 33 to 34, and may further comprise means for causing the closet controller circuitry to disposition apparel listed in the apparel inventory data for at least one of service or removal based on at least one of the apparel sensor data and the styling data.

Example 36 may include the elements of any of examples 33 to 35, and may further comprise means for causing the closet controller circuitry to determine a mood for the user based on at least on the user sensor data and means for inputting the mood into the apparel control logic.

Example 37 may include the elements of any of examples 33 to 36, wherein the styling data is received from an apparel manufacturer, the styling data including at least one piece of apparel suggested by the manufacturer.

Example 38 may include the elements of example 37, and may further comprise means for determining that the styling data includes suggested new apparel for purchase from the manufacturer and means for causing the user interface circuitry to present a user interface to allow the user to purchase the new apparel.

Example 39 may include the elements of any of examples 33 to 38, and may further comprise means for removing the at least one piece of apparel presented to the user from possible pieces of apparel to suggest to the user in the apparel inventory data based on the user not accepting the at least one piece of apparel presented to the user via the user interface circuitry.

Example 40 may include the elements of any of examples 33 to 39, wherein the styling data is received from an apparel manufacturer, the styling data including at least one piece of apparel suggested by the manufacturer, the system further comprising means for determining that the styling data includes suggested new apparel for purchase from the manufacturer and means for causing the user interface circuitry to present a user interface to allow the user to purchase the new apparel.

According to example 41 there is provided a control device to suggest apparel. The control device may comprise communication circuitry to at least receive user sensor data, apparel sensor data and styling data, memory circuitry to store an inventory of apparel for a user, context data, the user sensor data, the apparel sensor data, the styling data and apparel control logic, user interface circuitry and processing circuitry to input the apparel inventory, the context data, the user sensor data, the apparel sensor data and the styling data into the apparel control logic and to cause the user interface circuitry to present a suggestion of at least one piece of apparel to the user based on an output of the apparel control logic.

According to example 42 there is provided a method for controlling apparel suggestion. The method may comprise receiving user sensor data, apparel sensor data and styling data in a device including communication circuitry, memory circuitry, processing circuitry and user interface circuitry, storing an inventory of apparel for a user, context data, the user sensor data, the apparel sensor data, the styling data and apparel control logic in the memory circuitry, causing the processing circuitry to input the apparel inventory, the context data, the user sensor data, the apparel sensor data and the styling data into the apparel control logic and causing the user interface circuitry to present a suggestion of at least one piece of apparel to the user based on an output of the apparel control logic.

According to example 43 there is provided a system for controlling apparel suggestion. The system may comprise means for receiving user sensor data, apparel sensor data and styling data in a device including communication circuitry, memory circuitry, processing circuitry and user interface circuitry, means for storing an inventory of apparel for a user, context data, the user sensor data, the apparel sensor data, the styling data and apparel control logic in the memory circuitry, means for causing the processing circuitry to input the apparel inventory, the context data, the user sensor data, the apparel sensor data and the styling data into the apparel control logic and means for causing the user interface circuitry to present a suggestion of at least one piece of apparel to the user based on an output of the apparel control logic.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A control device to suggest apparel, comprising:
communication circuitry to at least receive user sensor data, apparel sensor data and styling data;
user interface circuitry; and
closet controller circuitry to input at least apparel inventory data, context data, the user sensor data, the apparel sensor data and the styling data into apparel control logic and cause the user interface circuitry to present to the user at least one of a suggestion of at least one piece of apparel or an alert regarding at least one piece of apparel based on an output of the apparel control logic.

2. The device of claim 1, wherein the user sensor data is received in the communication circuitry from sensor circuitry that senses at least one of a physical dimension of the user, a facial characteristic of the user, a gesture made by the user or a sound generated by the user.

3. The device of claim 2, wherein the closet controller circuitry is to determine a mood for the user based on at least one of the facial characteristic of the user, the gesture made by the user or the sound generated by the user sensed by the sensor circuitry and input the mood into the apparel control logic.

4. The device of claim 2, wherein the apparel sensor data is received in the communication circuitry from sensor circuitry that senses at least one of apparel usage or apparel condition.

5. The device of claim 4, wherein the closet controller circuitry is to cause the communication circuitry to request the user sensor data and the apparel sensor data from the sensor circuitry based on at least one triggering event.

6. The device of claim 4, wherein the styling data is received from at least one external resource including at least a data handling resource maintained by an apparel manufacturer, the styling data including at least one piece of apparel suggested by the manufacturer.

7. The device of claim 6, wherein the communication circuitry is to transmit at least the apparel sensor data to the at least one external resource for use in determining the styling data.

8. The device of claim 6, wherein the styling data further comprises suggestions of new apparel to purchase from the manufacturer, the closet controller circuitry further causing the user interface circuitry to present a user interface to the user allowing the new apparel to be purchased.

9. The device of claim 6, wherein the at least one external resource comprises a data accumulation resource for at least one third party, the styling data being generated at least in part based on data collected provided from the at least one third party.

10. The device of claim 1, wherein the closet controller circuitry is to disposition apparel listed in the apparel inventory data for at least one of service or removal based on at least one of the apparel sensor data and the styling data.

11. The device of claim 1, wherein the context data comprises at least one of a context of an event for which apparel is required or environmental data.

12. A method for controlling apparel suggestion, comprising:
receiving user sensor data, apparel sensor data and styling data in a device including communication circuitry, user interface circuitry and closet controller circuitry;
causing the closet controller circuitry to input apparel inventory data, context data, the user sensor data, the apparel sensor data and the styling data into apparel control logic; and
causing the user interface circuitry to present to a user at least one of a suggestion of at least one piece of apparel or an alert regarding at least one piece of apparel based on an output of the apparel control logic.

13. The method of claim 12, further comprising:
causing the communication circuitry to transmit at least the apparel sensor data.

14. The method of claim 12, further comprising:
causing the closet controller circuitry to disposition apparel listed in the apparel inventory data for at least one of service or removal based on at least one of the apparel sensor data and the styling data.

15. The method of claim 12, further comprising:
causing the closet controller circuitry to determine a mood for the user based on at least the user sensor data; and
inputting the mood into the apparel control logic.

16. The method of claim 12, wherein the styling data is received from an apparel manufacturer, the styling data including at least one piece of apparel suggested by the manufacturer.

17. The method of claim 16, further comprising:
determining that the styling data includes suggested new apparel for purchase from the manufacturer; and
causing the user interface circuitry to present a user interface to allow the user to purchase the new apparel.

18. The method of claim 12, further comprising:
removing the at least one piece of apparel presented to the user from possible pieces of apparel to suggest to the user in the apparel inventory data based on the user not accepting the at least one piece of apparel presented to the user via the user interface circuitry.

19. At least one machine-readable storage medium having stored thereon, individually or in combination, instructions for controlling apparel suggestion that, when executed by one or more processors, cause the one or more processors to:
receive user sensor data, apparel sensor data and styling data in a device including communication circuitry, user interface circuitry and closet controller circuitry;
cause the closet controller circuitry to input apparel inventory data, context data, the user sensor data, the apparel sensor data and the styling data into apparel control logic; and
cause the user interface circuitry to present to a user at least one of a suggestion of at least one piece of apparel or an alert regarding at least one piece of apparel based on an output of the apparel control logic.

20. The storage medium of claim 19, further comprising instructions that, when executed by one or more processors, cause the one or more processors to:
cause the communication circuitry to transmit at least the apparel sensor data.

21. The storage medium of claim 19, further comprising instructions that, when executed by one or more processors, cause the one or more processors to:
cause the closet controller circuitry to disposition apparel listed in the apparel inventory data for at least one of service or removal based on at least one of the apparel sensor data and the styling data.

22. The storage medium of claim 19, further comprising instructions that, when executed by one or more processors, cause the one or more processors to:
cause the closet controller circuitry to determine a mood for the user based on at least the user sensor data; and
input the mood into the apparel control logic.

23. The storage medium of claim 19, wherein the styling data is received from an apparel manufacturer, the styling data including at least one piece of apparel suggested by the manufacturer.

24. The storage medium of claim 23, further comprising instructions that, when executed by one or more processors, cause the one or more processors to:
determine that the styling data includes suggested new apparel for purchase from the manufacturer; and
causing the user interface circuitry to present a user interface to allow the user to purchase the new apparel.

25. The storage medium of claim 19, further comprising instructions that, when executed by one or more processors, cause the one or more processors to:
remove the at least one piece of apparel presented to the user from possible pieces of apparel to suggest to the user in the apparel inventory data based on the user not accepting the at least one piece of apparel presented to the user via the user interface circuitry.
